(19) United States
(12) Patent Application Publication
(10) Pub. No.: US 2014/0290977 A1
(43) Pub. Date: Oct. 2, 2014

(54) SEMI-FINISHED PRODUCT IN THE FORM OF A CONDUCTIVE STRIP THAT CAN BE EMBEDDED IN A COMPOSITE MATERIAL, AND METHOD FOR MANUFACTURING SUCH A STRIP

(71) Applicant: EUROPEAN AERONAUTIC DEFENCE AND SPACE COMPANY EADS FRANCE, Paris (FR)

(72) Inventors: Jesus Aspas Puertolas, Paris (FR); Nicolas Maisonnave, Paris (FR); Mathieu Sauzedde, Thiers (FR); Michel Bermudez, Suresnes (FR)

(73) Assignee: EUROPEAN AERONAUTIC DEFENCE AND SPACE COMPANY EADS FRANCE, Paris (FR)

(21) Appl. No.: 14/117,054

(22) PCT Filed: May 15, 2012
(86) PCT No.: PCT/EP12/59056

§ 371 Date: Nov. 12, 2013

(30) Foreign Application Priority Data
May 27, 2011 (FR) 11 54667

(51) Int. Cl. H01B 7/02; H01B 13/06

(52) U.S. Cl. CPC H01B 7/02; H01B 13/06
USPC 174/113 R; 29/825; 174/110 R

(57) ABSTRACT

A strip of a semi-finished product (101, 102), suitable for being deposited by lay-up, for the constitution of a laminated composite material, includes, according to a cross-section and over all its length: a first conductive layer (105, 106), made of an electric conductive material; two electric insulating layers (121, 122), made of a dielectric material completely surrounding the conductive layer (105, 106), the cross sectional width of which is greater than the width of the conductive layer; and two bonding layers (111, 112), extending in thickness on either side of the insulating layers (121, 122), on the exterior of the strip (101, 102). A method for the continuous production of such a strip is also described.

The invention concerns a semi-finished product in the form of a conductive strip that can be embedded in a laminated composite material. The invention is particularly, but not exclusively, applicable in the aeronautic domain, for the production of elements made of composite materials, reinforced by a fibrous reinforcement in a matrix made from a polymer, in order to confer to these structural elements, electrical conduction capabilities.

Structural elements made of a laminated composite material with a fibrous reinforcement and presenting, in addition, properties of electric conduction are described in the prior art, and particularly in the document FR-A-2924894. This document outlines a laminated structural part comprising, between two plies of fibrous reinforcement, a layer comprising a network of conducting cables. Said document also describes a method for obtaining such a structural element, wherein layers of conducting cables are inserted between one or several pairs of structural plies, in order to constitute a dry preform, the ensemble then being impregnated with a resin by a method of transferring the resin in order to constitute the matrix and to enable cohesion of the composite material. This method for obtaining a structural element by resin transfer is however not adapted, or proves to be inefficient, for certain parts, particularly parts which are of low thickness and of large size, such as fuselage panels, where such a method cannot compete, in terms of productivity, particularly with methods implementing the lay-up of pre-impregnated plies.

In order to resolve the disadvantages of the prior art, the invention proposes a semi-finished product, particularly in the form of a strip, suitable for being deposited by lay-up for the constitution of a laminated composite material wherein the semi-finished product comprises, according to a cross-section and over all its length:
a. a first conductive layer made of an electrically conductive material;
b. two electrically insulating layers made of a dielectric material, completely surrounding the conductive strip, the cross-sectional width of which is greater than the width of the conductive strip;
c. two bonding layers extending in thickness on either side of the insulating layers on the exterior of the semi-finished product.

Thus, the semi-finished product, according to the invention, comprises bonding layers allowing, on the one hand, to ensure the bonding of said semi-finished product with a preform during the lay-up process, and on the other hand, the cohesion of the conductive layer with the ensemble of the lamination of the composite material, during the curing or the consolidation of the pile constituting the part wherein said conductive layer is incorporated. Thus, such a part, incorporating a conductive layer, can be produced by manual or automated lay-up techniques, implementing pre-impregnated plies.

The invention can be implemented according to the favourable embodiments, outlined below, which can be considered individually or according to any technically feasable combination.

Advantageously, the insulating layers are made from a partially vulcanised elastomer. Besides ensuring electrical insulation of the conductive layer, this elastomer layer confers to the laminated part comprising a conductive layer, incorporated into said part via a semi-finished product according to the invention, vibroacoustic absorption capabilities and a mechanical protection ability of said conductive layer. The partial vulcanisation of the insulating layers allows the refinement of this vulcanisation during the curing of the laminated part incorporating the semi-finished product according to the invention, and to thus ensure a strong cohesion of the conductive layers with the rest of the part.

For example, the insulating layers are made from a partially vulcanised elastomer with a vulcanisation rate of approximately 60%. Such a partial vulcanisation is achieved by heating over a short time. For information, the heating temperature is generally approximately 110° C.

Advantageously, the bonding layers are made from a thermosetting adhesive. Therefore, the semi-finished product presents an adequate tack for it to be deposited by lay-up onto a preform.

According to a particular embodiment, the bonding layers are made of a thermoplastic polymer. This feature improves the resistance to impact and to heat stresses of the laminated ensemble wherein such a semi-finished product is incorporated.

According to this particular embodiment, the thermoplastic polymer comprises polyetherimide or PEI. This polymer being at least partially miscible in numerous thermosetting and thermoplastic resins, this feature ensures a strong cohesion of the conductive layer with the rest of the laminated composite part.

According to another advantageous embodiment, the insulating layers and the bonding layers are made from a partially polymerised thermosetting resin. Thus, the semi-finished product, the subject of the invention, incorporates itself perfectly by lay-up into a lamination of plies pre-impregnated with such a thermosetting resin. The partial polymerisation allows the conservation of both the cohesion of the semi-finished product, the subject of the invention, during the lay-up as well as its flexibility, necessary for this lay-up.

For example, the insulating layers and the bonding layers are made of a partially polymerised thermosetting resin, with a resin polymerisation rate of 60 to 80%. Such a partial polymerisation is achieved by heating for a short time. For information, the heating temperature is generally around 80° C. to 110° C., according to the resins used.

According to an embodiment, alternative to the previous one, the insulating layers and the bonding layers are made from a thermoplastic elastomer comprising polyetherimide (PEI). Thus, the semi-finished product, the subject of the invention, is suitable to be incorporated into a lamination constituting a thermoplastic or thermosetting matrix composite.

According to a first variant of the semi-finished product, the subject of the invention, compatible with all previous embodiments, the conductive layer is made of a metallic foil, a metallic braid or cable. The fineness of such a foil allows the strip to fit closely to any type of shape, including double-curved shapes.

Advantageously, said metallic foil is made of an aluminium alloy which can be obtained by rolling an extremely fine thickness, and which has a low volumic mass. The metallic foil can also be made of a copper alloy.

According to a second variant, also compatible with the previous embodiments, the conductive layer is made of multiple metallic conductors, electrically insulated from each other. Thus, on the one hand, several different electrical signals can be transmitted in each one of the conductors, and the lateral separation of the conductors from each other allows the use of thicker conductors without damaging the shaping capability of the semi-finished product.

The invention also concerns a method for the production of such a semi-finished product according to the different embodiments, wherein the semi-finished product comprises elastomer insulating layers, said method comprising the steps consisting of:
a covering by a calendering process a strip of electrically conductive material by two raw elastomer layers;
b vulcanising the ensemble, constituted during the previous step;
c conditioning the ensemble in the form of a roll, suitable for being used in a lay-up machine.

Thus, the method, the subject of the invention, allows to produce in an automatic way, large quantities of semi-finished product, conditioned in the form of strips or coils, wherein the coils can be stored and incorporated, inasmuch as it is necessary, into laminates constituting composite material parts.

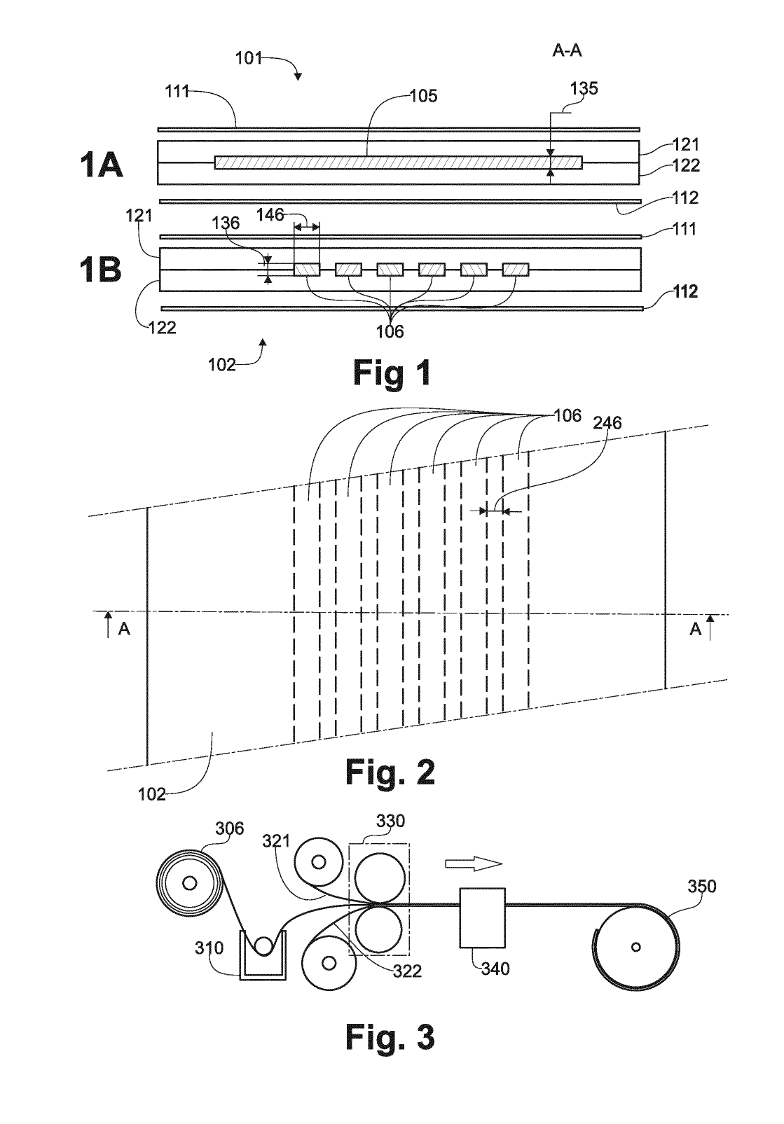

The invention is outlined below according to its preferred embodiments, in no way limiting, and in reference to FIGS. 1 to 3, wherein:

FIG. 1 is an exploded and sectional view according to the A-A section, illustrated in FIG. 2, of two examples of producing a semi-finished product according to the invention, FIG. 1A, according to a variant of realisation, comprising a foil as a conductive layer and FIG. 1B, according to a variant of realisation where this conductive layer comprises multiple conductors;

FIG. 2 represents, according to an elevated view, a semi-finished product according to a variant realisation of the invention, comprising multiple conductors in the conductive layer;

and FIG. 3 is a synoptic of an example of a method for continuous production of a semi-finished product according to the invention.

FIG. 1, according to a first example of realisation of a semi-finished product (101, 102), the subject of the invention, includes, at the core, a conductive layer (105, 106) which, according to a first variant (101) of realisation, can be made of a metallic foil (105), FIG. 1A, or, according to a second variant (102), made of multiple conductors (106) in layers, FIG. 1B, preferentially in the form of flat metallic cables. This conductive layer (105, 106) is surrounded by two insulating layers (121, 122), made of a dielectric material, preferentially, but not exclusively, an elastomer. Advantageously, the semi-finished product (101, 102), according to the invention, comprises two layers (111, 112), known as bonding layers, presenting interface characteristics, rendering said semi-finished product (101, 102) suitable for lay-up on an automatic lay-up machine, and suitable for forming a cohesive interface with pre-impregnated fibrous reinforced layers, following a curing or consolidation process. Said bonding layers (111, 112) can be layers related to the insulating layers, by hot or cold impregnation of these layers, or be an integral part of said insulating layers.

Said insulating layers (121, 122) must be sufficiently thick to ensure total electrical insulation of the conductive layer (105, 106) from its environment in the finished product, that is to say, after the semi-finished product (101, 102), the subject of the invention, has been subjected to form lay-up, for it to be inserted into the core of a laminate, following by a curing or consolidation process at high temperature and under pressure. This insulation must be complete and effective, especially for high voltages, of approximately 3000 volts. Thus, the insulating layers (121, 122) must also be hermetic, but have sufficient flexibility to allow the semi-finished product (101, 102) to be rolled, in view of its installation on an automatic lay-up machine, and to be able to withstand stringing and pressing on the preform without degrading the integrity of said layers under these mechanical stresses. Finally, once placed in the finished product within a pile of plies, reinforced by high-performance fibres, the semi-finished product (101, 102), the subject of the invention, must support the transfer of mechanical loads between the plies located on either side of said semi-finished product, without constituting a weak area in the pile, and without losing its integrity as regards its electrical insulation and hermetic properties.

Answering all of these specifications leads to contradictory properties. Thus, an effective transfer of stresses through the semi-finished product incorporated into the finished product leads to favouring the rigidity of the strip, whereas the vibroacoustic absorption and protective properties of the conductors lead to favouring the flexibility of the strip. The conditions also depend on the thickness of the semi-finished product (101, 102), and consequently, on the cross-section of the conductive layer (105, 106) at the core of said semi-finished product.

Thus, according to an example of realisation, FIG. 1A, the conductive layer (105) is made of a foil. Said foil (105) can be made of a sheet of copper or aluminium alloy. Said foil (105) being fine, it is highly suitable for lay-up operations. As a non-limiting example, the foil has a width of 20 mm, which, for a conductive section of 1 mm², leads to a thickness (135) of said foil of 0.05 mm. This foil, with a low thickness, can be inserted into the fine resin layers, thus, the insulating layers (121, 122) can be made of a thermosetting resin, partially polymerised, for example with a resin polymerisation rate of approximately 60 to 80%. This partial polymerisation, placing said resin in a semi-cured state, allows said resin to conserve a certain tack, so that the bonding layers (111, 112) are constituted by the exterior of the insulating layers (121, 122). The flexibility of the strip is then sufficient to be layed up, but is of a sufficient rigidity to support said foil and avoid being creased during these lay-up operations. The subsequent curing of the lamination corresponding to the finished part allows, by the polymerisation of the ensemble, to achieve a strongly cohesive bonding of the semi-finished product (101) with the rest of the part.

According to another example of realisation, FIG. 1B, the conductive layer (106) is made of multiple conductors, for example in the form of flat cables. This configuration allows different signals to be transmitted through each of the conductors. On the other hand, the cross-section of each conductor must be sufficient individually so that, compared with the foil (105), this technical solution leads to a thickness (136) distinctly greater than each of the conductors. As a non-limiting example, each flat cable having a width (146) of 2 mm, a conductive cross-section of 1 mm² is obtained for a thickness (136) of conductors of 0.5 mm. Also, this embodiment leads to a distinctly increased thickness of the semi-finished product (102).

Moreover, FIG. 2, each flat cable must be transversally separated from the one next to it, of a sufficient distance (246), typically of the same order as the width (146) of the cable. This distance must also be filled by the insulating layers (121, 122).

By referring to FIG. 1B, according to this embodiment comprising a conductive layer (106), comprising multiple conductors, the insulating layers (121, 122) are advantageously made from a partially vulcanised elastomer. Thus, the flexibility of the insulating layers (121, 122) is tested at different stages of production of the semi-finished product (102), and its implementation for the constitution of a laminated structural part, by the vulcanisation rate of said insulating layers (121, 122).

FIG. 3, according to an example of continuous production of the semi-finished product, the subject of the invention, the conductors or the foil are uncoiled from a roll (306) of great length. After a continuous surface treatment (310), two strips (321, 322) are put onto said conductors or foil by rolling (330) or calendering. Advantageously, the two strips (321, 322) are made from raw elastomer.

In this raw state, the elastomer strips (321, 322) are very malleable and plastic and, during the calendering operation (330), they fit perfectly to the conductors (306), and particularly fill the spaces between said conductors. The assembly thus achieved, is then partially vulcanised by passing through a curing unit (340), for example with a vulcanisation rate of approximately 60%.

At the end of this partial vulcanisation, the insulating elastomer layers reach a cohesion and an elastic behaviour which allows to coil (350) the strip on a roll for their installation on an automatic lay-up machine and the depositing of said strip by lay-up on an adhesive preform.

After having been incorporated into the preform, the semi-finished product, partially vulcanised, is cured or consolidated with said preform. During this curing process, according to the vulcanisation rate of the insulating layers (121, 122), their rigidity increases, so that a mechanical transfer of stresses can be achieved through said semi-finished product. The presence of polyetherimide in the elastomer constituting said insulating layers (121, 122) allows a strong chemical cohesion between the semi-finished product, the subject of the invention, and the rest of the lamination, due to the at least partial miscibility of this polymer, as much in the thermoplastic resins as in the thermosetting resins. Thus, a very rigid laminate, allows an effective transfer of stresses on either side of the semi-finished product (101, 102), the subject of the invention, when this is incorporated in the final part. The elasticity of the semi-finished product confers to the structural part incorporating said semi-finished product vibroacoustic shock absorption capabilities.

The description above and the examples of embodiment show that the invention reaches the targeted objectives, in particular it allows continuous and economical production of semi-finished products (101, 102), ready to be layed up using an automatic machine, and which can be incorporated, upon request, into the lamination of a fibrous-reinforced composite part, conferring to said part capabilities of delivering an electrical signal or power.

1-11. (canceled)

12. A semi-finished product, particularly in the form of a strip, suitable for being deposited by lay-up, for the constitution of a laminated composite material, wherein it includes, according to a cross-section and over all its length:
a. a first conductive layer, made of an electrically conductive material;
b. two electric insulating layers, made of a dielectric material completely surrounding the conductive layer, the cross sectional width of which is greater than the width of the conductive layer;
c. two bonding layers, extending in thickness on either side of the insulating layers, on the exterior of the semi-finished product.

13. The semi-finished product, according to claim 12, wherein the insulating layers are made from a partially vulcanised elastomer.

14. The semi-finished product, according to claim 13, wherein the bonding layers are made from a thermosetting adhesive.

15. The semi-finished product, according to claim 13 wherein the bonding layers are made from a thermoplastic polymer

16. The semi-finished product, according to claim 15, wherein the thermoplastic polymer constituting the bonding layers comprises polyetherimide.

17. The semi-finished product, according to claim 12, wherein the insulating layers and the bonding layers are made from a partially polymerised thermosetting resin.

18. The semi-finished product, according to claim 12, wherein the insulating layers and the bonding layers are made from a thermoplastic elastomer including polyetherimide.

19. The semi-finished product, according to claim 12, wherein the conductive layer is made of a metallic foil.

20. The semi-finished product, according to claim 19, wherein the foil is made of an aluminium alloy.

21. A semi-finished product, according to claim 12, wherein the conductive layer is made of multiple metallic conductors, electrically insulated from each other.

22. A method for the production of a semi-finished product according to claim 13, wherein it includes the steps consisting of:
a. covering by a calendering process a strip of electrically conductive material by two raw elastomer layers;
b. partially vulcanising the ensemble, constituted during the previous step;
conditioning the ensemble in the form of a roll, suitable for being used in a draping machine.
